(19) United States
(12) Patent Application Publication
(10) Pub. No.: US 2006/0050239 A1
(43) Pub. Date: Mar. 9, 2006

(54) Crane for shooting

(76) Inventor: Yuuji Hashimoto, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/268,666

(22) Filed: Nov. 8, 2005

Related U.S. Application Data
(63) Continuation of application No. PCT/JP04/02946, filed on Mar. 8, 2005.

(30) Foreign Application Priority Data
Jun. 20, 2003 (JP) 2003-176559

(51) Int. Cl. G03B 17/00

(52) U.S. Cl. 352/243

(57) ABSTRACT

A crane for shooting includes a crane base unit fixed to the movable stand, a curved boom supported on the crane base unit rotatably in the horizontal and up and down directions by means of a shaft and has an arch shape curved into an arc or U shape with downward opening, a pan head that supports a small video camera provided to the front end of the curved boom, a link mechanism that retains the pan head in a constant position with respect to the up and down movements of the curved boom, a weight for balance provided in the rear of the curved boom, and an operation handle provided in a downwardly projecting manner in the lower portion near the pan head of the curved boom.

This application is a continuation of PCT/JP04/02946, filed Mar. 8, 2004. This PCT application is a priority based on prior Japanese Patent Application of JP2003-176559, filed Jun. 20, 2003.

### TECHNICAL FIELD

The present invention relates to a crane for shooting that is used for taking pictures of surgery at medical treatment sites and so forth, and more particularly to a crane for shooting to take pictures of surgery without disturbing a surgeon.

### BACKGROUND ART

Conventionally, in various hospitals and medical facilities, work of filming of a manner of practical surgery and editing the pictures is conducted, and a crane for shooting is used at the time of the shooting. In many cases, a crane made for shooting for television broadcast is generally used in such an occasion.

(Patent document: Japanese Patent Application for Laid-Open Publication No. 1998-141588)

However, conventional cranes for shooting are too large and high in cost for use at medical treatment sites. Particularly, since shooting is conducted while watching a site undergoing surgery from above, it is often apt to disturb the surgery. Thus, it is possible that shooting is conducted taking a stance with a camera placed at a position a little far from the operating table and faced diagonally downward. However, there is a problem that the shooting may not be conducted properly because movements of the doctors and staffs participating in the surgery obstruct the shooting view.

The present invention has an object to provide a small and light crane for shooting that is excellent in operability and capable of taking pictures of a target site from just above it without obstructing anything at the shooting place.

### DISCLOSURE OF INVENTION

To achieve this object, the present invention is constructed as follows. The present invention is a crane for shooting that includes a crane base unit fixed to a movable stand, a curved boom supported rotatably in the horizontal and up and down directions with respect to the crane base unit by means of a shaft and having an arch shape curved into an arc or U shape with downward opening, a pan head that supports a shooting device arranged at the front end of the curved boom, a link mechanism that retains the pan head in a constant position with respect to the rotation of the curved boom in the up and down directions, and a weight for balance arranged in the rear of the curved boom.

Here, the stand supports the curved boom such that the inner height at the top of the curve of the curved boom exceeds man's height.

The link mechanism is a so called curved approximate parallel link mechanism, constructed of the curved boom, and includes a first link member one end of which is rotatably supported at a first supporting point on the crane base unit by means of a shaft and the other end of which is rotatably supported at a second supporting point on the pan head side by means of a shaft, a second link member with a multiple node link arranged along the first link member one end of which is rotatably supported at a third supporting point on the crane base unit by means of a shaft and the other end of which is rotatably supported at a fourth supporting point on the pan head side by means of a shaft, and a guide member fixed to the first link member and having guide grooves in the tangential direction in which the supporting points of the multiple node link of the second link member are fit slidably and loosely to restrain the movement of the second link member with respect to the first link member.

Further, in the link mechanism, the first link member constructed of the curved boom is a curved pipe member, the second link member has a plurality of curved link plates connected to each other, and the connecting shafts of the multiple node link of the second link member are fit slidably and loosely in the guide grooves of the guide member fixed to the inside of the pipe member.

The second link member is constructed of a two-node link in which three curved link plates are connected to each other at two positions, and each link connecting shaft of the second link member is fit slidably and loosely in the guide grooves of the guide member fixed at two positions inside the curved pipe member constructing the first link member.

The pan head includes an oscillation mechanism unit rotatable in the horizontal direction and provided to the front end of the curved boom, a three-dimensional rotation mechanism that rotates an attached shooting device relatively in the horizontal and vertical directions with respect to the oscillation mechanism unit, and a remote controlling unit that controls the oscillation mechanism and the three-dimensional mechanism.

Furthermore, the oscillation mechanism of the pan head is provided with a first motor that rotates the pan head side in the horizontal direction with respect to the front end of the curved boom, and the three-dimensional mechanism has a pipe member curved into an L shape and is not only provided rotatably with respect to the oscillation mechanism by a second motor installed on one side of the pipe member but also attached with an adaptor rotatably by a third motor installed on the other side of the pipe member on which a shooting device is attached.

The remote controlling unit of the crane for shooting includes an operation switch for the oscillation mechanism, an operation switch for the three dimensional rotation mechanism, and an operation switch for zooming of the shooting device.

Further, on the stand of the crane for shooting, a monitor display that displays pictures taken by the shooting device is provided. Furthermore, an operation handle is provided in a downwardly projecting manner in the lower portion near the pan head of the curved boom as necessary.

With such a crane for shooting of the present invention, it is possible, for example, to appropriately take pictures of surgery manners from above without obstructing the surgery and without disturbing the shooting views in a state where the stand on a cart is placed outside the space necessary around the operating table and the pan head attached with a small video camera is placed right above the operating table with the curved boom crossing over the heads of staffs.

Further, the curved boom has a curved, unique, parallel link mechanism that includes a first link and a second link arranged along the curved boom and serving as a multiple node link of which movement is restrained with respect to the first link and that can retain the shooting device in a constant position with respect to the up and down movements of the curved boom.

Particularly, the link connecting shafts is loosely fit in the guide grooves of the guide member fixed to the first link to restrain the movement of the second link of the parallel link mechanism as a multiple node link, which makes it possible to securely prevent buckling and breakage of the second link due to stress concentration when the second link is a simple curved link, and allows the second link to function substantially as a parallel link mechanism in a limited range such as 30 degrees between up and down.

Further, a curved pipe is used for the curved boom, and a multiple node link is arranged inside the pipe, thereby providing a structure in which the parallel link mechanism is not exposed outside and that is suitable for medical treatment sites where easy cleaning, adherence of little dust, and keeping of cleanliness are required.

Furthermore, by providing the oscillation mechanism that is rotated in the horizontal direction to the front end of the curved boom, it is possible for the shooting device to be positioned constantly with respect to an operation site viewed from above, for example, at a position to face up to the patient position, owing to oscillating rotation of the boom front end in the horizontal direction, thereby improving the flexibility of shooting stance significantly wherever the crane base arranged on the cart may be placed outside the operating table.

Since the operation handle projects downward in the lower portion of the front end of the curved boom, a staff member can change the camera position with ease by holding the operation handle with one hand, and therefore, it is possible to obtain significantly high operability.

### BRIEF DESCRIPTION OF DRAWINGS

FIG. 1 is a detailed diagram to explain an embodiment of a crane for shooting according to the present invention;

FIG. 2 is a detailed diagram to explain the crane for shooting viewed from the front according to the present invention;

FIG. 3 is a detailed diagram to explain the crane base unit in FIG. 1;

FIG. 4 is a detailed diagram to explain the curved boom in FIG. 1;

FIGS. 5A and 5B are detailed diagrams to explain a front end portion and a rear end portion of the curved boom in FIG. 1;

FIG. 6 is a cross sectional view of the inner structure of the curved boom in FIG. 1;

FIGS. 7A and 7B are detailed diagrams to explain a two-node link installed in the curved boom;

FIG. 8 is an enlarged cross sectional view of a portion of a guide member installed in the curved boom in FIG. 6;

FIG. 9 is a transverse sectional view of an installed portion of the guide member in the curved boom in FIG. 8;

FIG. 10 is a perspective view of the guide member;

FIG. 11 is a detailed diagram to explain a pan head attached to the front end of the curved boom;

FIG. 12 is a side view of the pan head in FIG. 11;

FIG. 13 is a detailed diagram to explain an operation box used for the crane for shooting;

FIG. 14 is a detailed diagram to explain another embodiment of the crane for shooting according to the present invention;

FIG. 15 is a side view of the boom in a horizontal position of the embodiment in FIG. 14; and

FIG. 16 is a detailed diagram to explain still another embodiment of the crane for shooting according to the present invention.

### BEST MODE FOR CARRYING OUT THE INVENTION

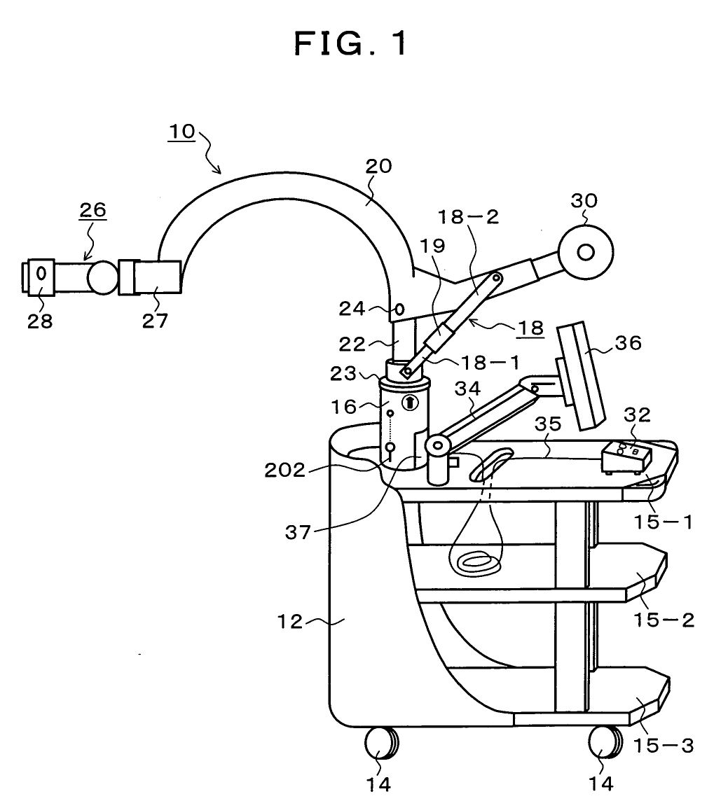

FIG. 1 is a detailed diagram to explain an embodiment of a crane for shooting according to the present invention. In FIG. 1, the crane for shooting of the present invention is structured to include a crane main body 10 and a cart 12. The cart 12 is provided with casters 14 in its lower portion and arranged with stands 15-1, 15-2, and 15-3 in three tiers in this embodiment. On the top stand 15-1 of the cart 12, the crane main body 10 is arranged via a crane base unit 16. With respect to the crane base unit 16, a curved boom 20 is arranged via a pivot shaft 22. The curved boom 20 is arranged rotatably in the horizontal direction on the pivot shaft 22. Further, the curved boom 20 is arranged rotatably in the up and down directions by the connection of a first supporting point shaft 24 to the pivot shaft 22 side. The crane base unit 16 is provided with a stopper 18, which allows the curved boom 20 to be fixed at an arbitrary up or down position in a rotatable state. In other words, in the stopper 18, a link 18-1 one end of which is rotatably attached to the pivot shaft base 23 as well as the link 18-2 the other end of which is rotatably attached to a balance weight 30 side of the curved boom 20 are slidably fit in to each other at the center of the stopper 18 and a locking slider 19 is arranged over this fit portion. When the locking slider is 19 moved upward, lock is released, thereby allowing the links 18-1 and 18-2 to slide freely. When the locking slider 19 is moved downward, the links 18-1 and 18-2 are locked.

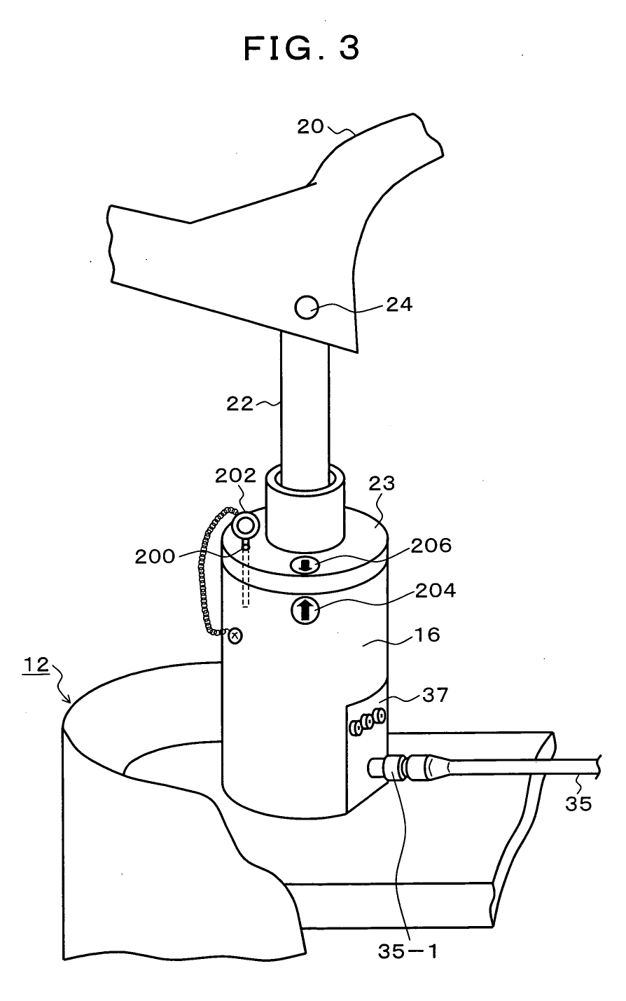

Locking of the curved boom 20 in the pivot direction is carried out with a lock key 202 hung on the crane base unit 16 with a chain, and this will be explained in FIG. 3. The curved boom 20 has an arch shape curved into an arc or U shape with downward opening and is supported on the stand 15-1 of the cart 12 such that the inner height at the upper portion of this curved boom exceeds man's height. A pan head 26 is attached to the front end of the curved boom 20 and is provided with a camera adaptor 28 to attach a small video camera. A flexible cover 27 is mounted over the connecting portion between the pan head 26 and the curved boom 20. An oscillation mechanism disclosed in the later explanation that allows the pan head 26 side to be rotated in the horizontal direction with respect to the front end of the curved boom 20 is provided inside the flexible cover 27. Moreover, a three-dimensional rotation mechanism that drives the camera adaptor 28 side pivotally in the horizontal and vertical directions is provided. A balance weight 30 is attached in the rear of the first supporting point shaft 24 that serves as a rotation shaft by which the curving boom 20 is moved up and down. Further, an operation box 32 is placed on the stand 15-1 of the cart 12. The operation box 32 is connected to a corresponding connector in a connector unit 37 provided in the crane base unit 16 by a cable 35, allows to operate remotely motors provided in the oscillation mechanism and the three-dimensional rotation mechanism in the pan head 26 side attached on the front end side of the curved boom 20, and further allows to control zooming of a lens of the small video camera attached to the camera adaptor 28. The remote control of the small video camera with the operation box 32 is performed while watching images being shot that are displayed on a monitor display 36 such as liquid crystal display device arranged on the stand 15-1.

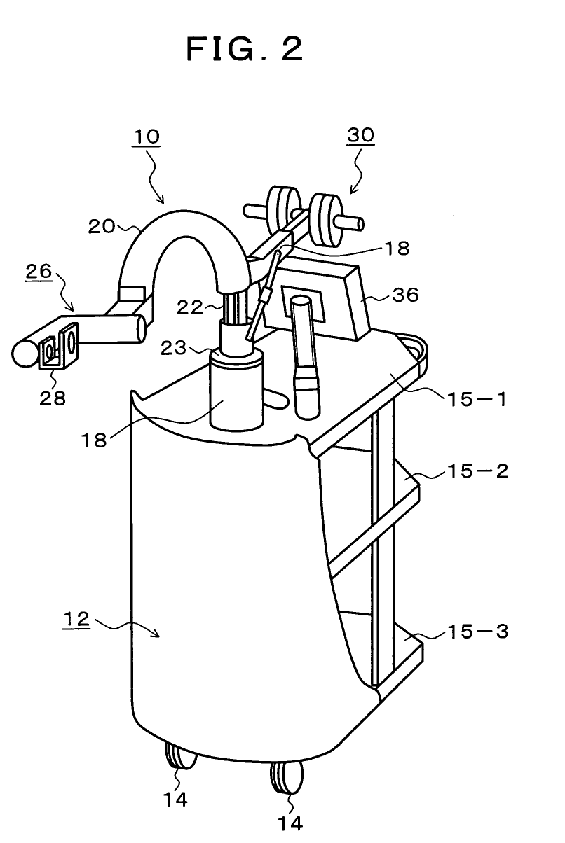

FIG. 2 is a detailed diagram to explain the crane for shooting of the present invention in FIG. 1 that is viewed from the front. In FIG. 2, a pipe member is curved to construct the curved boom 20 of the crane main body 10, and the pan head 26 attached to the front end of the curved boom 20 makes use of a pipe member curved into an L shape. In this way, both the curved boom 20 and the pan head 26 of the crane main body 10 make use of pipe members having a smooth surface, and therefore, it is easy to clean them when dust and the like adhere and is possible to keep cleanliness with ease when the crane for shooting is placed and used in an operating room.

FIG. 3 represents the crane base unit 16 in FIG. 1. A key hole 200 is provided at a predetermined position on the pivot cover 23 of the pivot shaft 22 supported by the crane base unit 16. When the lock key 202 is inserted into the key hole 202 in a state where the curved boom 20 is pivoted to a predetermined position and retained there, the lock key 200 is inserted into the key hole provided inside the crane base unit 16, and a pivot of the curved boom 20 is locked. An arrow marker 204 is displayed on the crane base unit 16, and an arrow marker 206 is displayed on the top surface of the pivot cover 23. When the positions of the arrow markers 204 and 206 coincide with each other as shown, the key hole 200 corresponds to the position of the key hole in the inside on the crane base unit 16 side, thereby making it possible to insert the lock key 202 to lock a pivot. Locking a pivot of the curved boom 20 with the use of the lock key 202 is utilized when the crane for shooting of the present invention is transported. The connector unit 37 is provided to the crane base unit 16 and the cable 35 from the operation box 32 is connected to a connector 35-1. Further, to the connector unit 37 are provided a video signal terminal, an audio signal terminal, a digital video (DV) signal terminal, and a Lank signal terminal. The lock position at which the lock key 202 is inserted is in a state where the pivot boom 20 is pivoted to the cart 12 side showing the back of the pivot boom 20 in front.

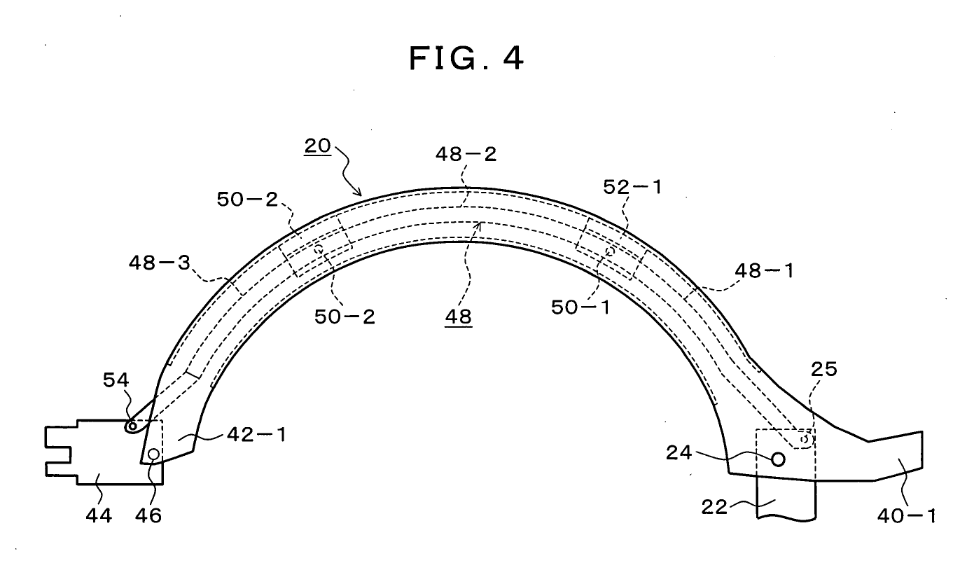

FIG. 4 is a detailed diagram to explain the curved boom 20 provided to the crane main body in FIG. 1 after separating them. In FIG. 4, the curved boom 20 is a hollow metal pipe, to which a boom rear end unit 40-1 is fixed to the pipe end on the rear end side of the curved boom 20 and a boom front end unit 42-1 is fixed on the front end thereof.

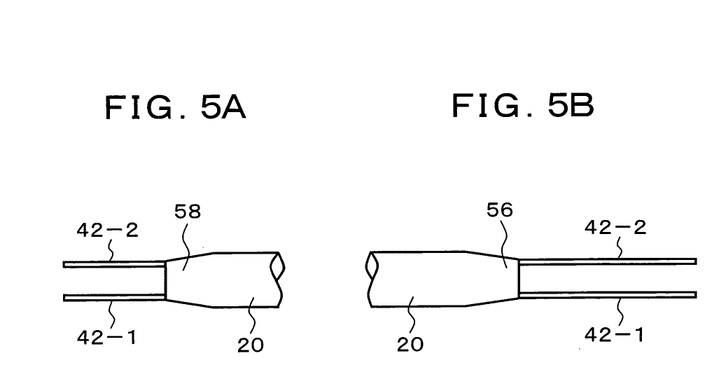

The detail of the sides of the front end and the rear end of the curved boom 20 is separately illustrated in FIGS. 5A and 5B.

FIG. 5A represents the front end side of the curved boom 20, and boom front end units 42-1 and 42-2 having been divided into two via a front detachment unit 58 are provided to the pipe front end of the curved boom 20. Further, FIG. 5B represents the rear end side of the curved boom 20, and boom rear end units 40-1 and 40-2 having been divided into tow via a rear detachment unit 56 are provided to the pipe rear end of the curved boom 20. Note that FIGS. 5A and 5B are detailed diagrams to explain a state of the boom front end side and the boom rear end side in FIGS. 5A and 5B in which the front end and the rear end of the boom in FIG. 3 are viewed from the outside that is the radial direction with respect to the center of curvature of the curved boom 20

Again referring to FIG. 4, the boom rear end unit 40-1 of the curved boom 20 is arranged rotatably up and down by a first supporting point shaft 24 with respect to the pivot shaft 22. Further, the boom front end unit 42-1 is arranged rotatably by a second supporting point shaft 46 with respect to a tip fitting 44. A two-node link 48 is installed inside the curved boom 20 and its rear end side is connected to the pivot shaft 22 by a third supporting point shaft 25. Its front end side is connected to the tip fitting 44 by a fourth supporting point shaft 54. The two-node link 48 is a multiple node link member in which three link plates 48-1, 48-2, and 48-3 are connected to each other by connecting shafts 50-1 and 50-2, respectively, at two positions. In addition, guide members 52-1 and 52-2 are fixed at the positions corresponding to the connecting shafts 50-1 and 50-2, respectively, of the two-node link 48 inside the curved boom 20 to restrain movement of the two-node link 48 with respect to the curved boom 20.

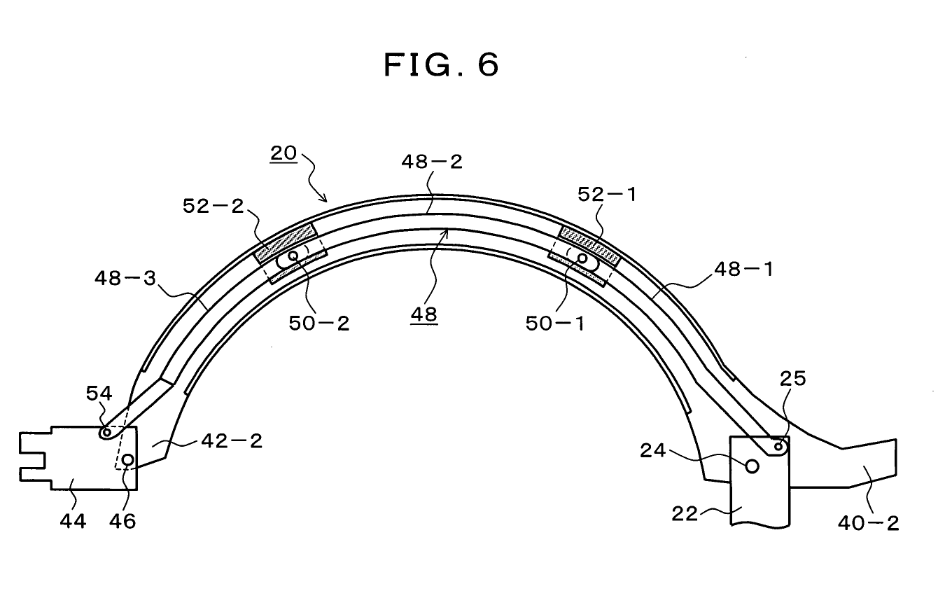

FIG. 6 is a cross sectional view of the inner structure of the curved boom 20 in FIG. 4. The curved boom 20 is a hollow pipe member, the boom rear end unit 40-2 is connected to the pivot shaft 22 by the first supporting point shaft 24, and the boom front end unit 42-2 is connected to the tip fitting 44 by the second supporting point shaft 46. Further, the two-node link 48 is arranged along the curved boom 20 inside the curved boom 20. The link plates 48-1, 48-2, and 48-3 of the two-node link 48 are connected to each other by the supporting point shafts 50-1 and 50-2, respectively, the rear end side is connected to the pivot shaft 22 by the third supporting point shaft 25, and the front end side is connected to the tip fitting 44 by the fourth supporting point shaft 54. Furthermore, the guide members 52-1 and 52-2 are fixed at the positions corresponding to the connecting shafts 50-1 and 50-2 of the two-node link 48 inside the curved boom 20.

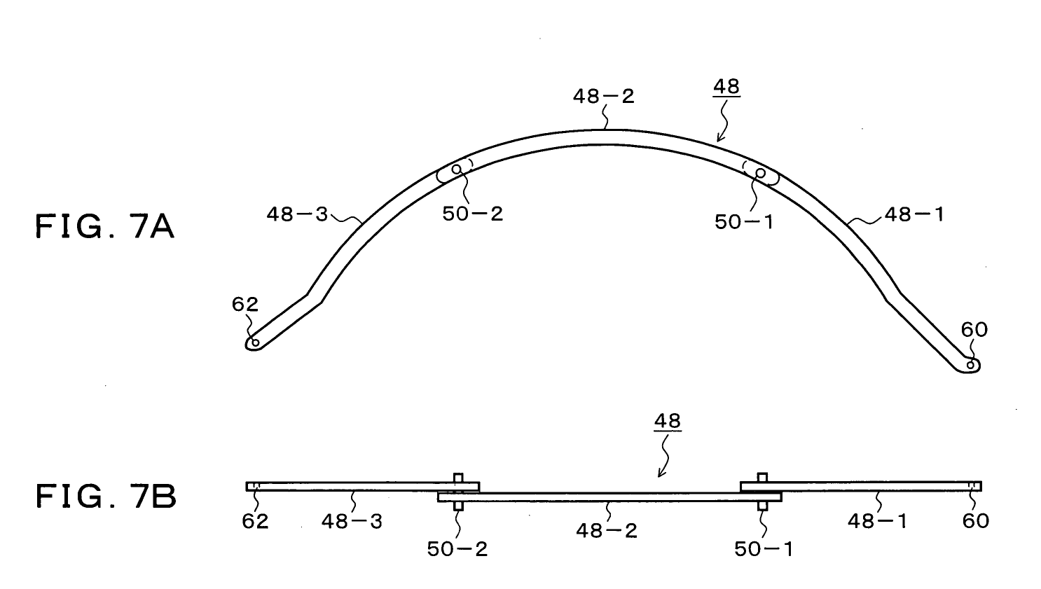

In FIGS. 7A and 7B, the two-node link 48 in FIG. 6 is taken out, its side view is shown in FIG. 7A, and its plan view is shown in FIG. 7B. The three link plates 48-1, 48-2, and 48-3 of the two-node link 48 are connected to each other by the connecting shafts 50-1 and 50-2, respectively. As shown in FIG. 7B, the connecting shafts 50-1 and 50-2 project to the both sides from the portions of the link plates 48-1 and 48-2 overlaid on each other and the portions of the link plates 48-2 and 48-3 overlaid on each other, respectively. The projecting portions of the both sides of the connecting shaft 50-1 and 50-2 respectively fit in guide grooves of the guide members 52-1 and 52-2 provided to the curved boom 20 in FIG. 6. The three link plates 48-1 to 48-3 constructing the two-node link 48 are arranged in an arc form and have a sufficient width when viewed from the side of FIG. 7A, thereby obtaining sufficient rigidity against the power applied in the vertical direction of the link.

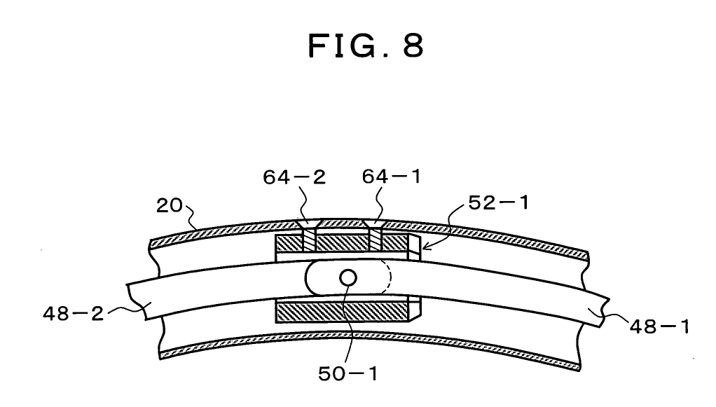

FIG. 8 is an enlarged cross sectional view of an installed portion of the guide member 52-1 in the curved boom 20 in FIG. 6. In FIG. 8, the guide member 52-1 is fixed to the inside of the curved boom 20 by flat-head screws 64-1 and 64-2, and the connecting portion of the link plate 48-1 to the link plate 48-2 is allowed to run through the portion with downward opening.

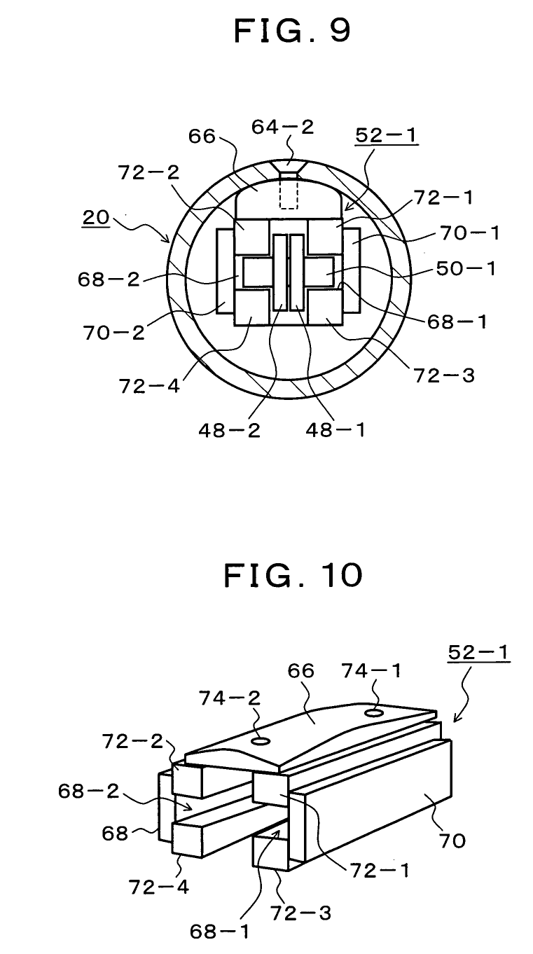

FIG. 9 is a transverse sectional view of the installed portion of the guide member 52-1 in FIG. 8. The guide member 52-1 taken out is shown in FIG. 10. As is clear from FIG. 10, as to the guide member 52-1, upper guide members 72-1 and 72-2 are fixed with a predetermined guide space between them beneath a fixing member 66 in the upper portion of the guide member 52-1, lateral guide members 70-1 and 70-2 are fixed to the outer sides of the upper guide members 72-1 and 72-2, respectively, and lower guide members 72-3 and 72-4 are fixed to the lower inner sides of the lateral guide members 70-1 and 70-2, respectively. In such a structure, guide grooves 68-1 and 68-2 are formed on both sides of inner sides of the inside. This guide member 52-1 is fixed to the inside of the curved boom 20 by the flat-head screws 64-1 and 64-2 as shown in FIG. 9 and in this fixed state, the guide grooves 68-1 and 68-2 are located in the tangential direction with respect to the arc of the curved boom 20. Both ends of the connecting shaft 50-1 connecting the link plates 48-1 and 48-2 to each other are fit slidably and loosely in the guide grooves 68-1 and 68-2 of the guide member 52-1, respectively.

The dimensional relation between the connecting shaft 50-1 and the guide grooves 68-1 and 68-2 is determined so as to secure a clearance between them.

Providing a little space between the guide grooves 68-1 and 68-2 and the connecting shaft 50-1 allows movement of the curved boom 20 in a range of, for example, ca.±30 degrees up and down with respect to horizontal position by curved parallel link mechanism constructed of the curved boom 20 and the two-node link 48.

A further detailed explanation of the curved parallel link mechanism of the crane for shooting of the present invention is as follows. In FIG. 6, the curved boom 20 corresponds to a first link member in the parallel link mechanism consisting of four links arranged in parallel, and a second parallel link member facing to the first link member is constructed of the two-node link 48. The curved boom 20 as the first link member and one end of the two-node link 48 as the second link member are connected to each other by the first supporting point shaft 24 and the third supporting point shaft 25 with respect to the pivot shaft 22 serving as a fixed side, and a virtual link that connects these two supporting point shafts 24 and 25 to each other is a third link and serves as a fixed link. Further, the front end of the curved boom 20 constructing the first link member and the front end of the two-node link 48 constructing the second link member are connected to each other by the second supporting point shaft 46 and the fourth supporting point shaft 54 with respect to the tip fitting 44. A virtual link that connects the second supporting point shaft 46 and the fourth supporting point shaft 54 to each other is a fourth link. This fourth link serves as a movable link that moves in parallel with a constant positional relation with respect to the fixed link (the third link) on the pivot shaft 22 side.

In a common parallel link mechanism, four links that connect the four supporting point shafts 24, 25, 46, and 54 are in a parallel relation with respect to the links facing each other; however, it is said that the crane for shooting of the present invention has a unique structure in terms of the first link and the second link that are curved into an arc or U shape with downward opening as rotational links with respect to the fixed side including the first supporting point shaft 24 and the third supporting point shaft 25. In such a parallel link mechanism in which link members facing each other are curved, the two curved links should support a load applied to the front end side, and therefore, when the parallel link mechanism has simple parallel curved links, rigidity of each link should significantly be made high, which makes the structure complex and large. Because of this, in the present invention, the curved boom 20 making use of a pipe member as the link member to support a load added to the front end is allowed to serve as the first link member, and the two-node link 48 is arranged inside the pipe member as the second link member to adjust the positional relation between the front end side and the rear end side.

Here, as to the crane for shooting of the present invention, when a position in the height direction of a small video camera attached to the front end of the curved boom 20 is adjusted, a portion of the small video camera attached to the tip of the tip fitting 44, for example, the pan head is moved up and down. Therefore, a downward power is applied to the tip fitting 44 when the curved boom 20 is lowered, and an upward power is applied when the curved boom 20 is moved up. With respect to the downward power to the tip fitting 44, the two-node link 48 receives a tension on the fixed side. In reverse, with respect to the upward power to the tip fitting 44, the two-node link 48 receives a compression power on the fixed side. Such a tension and a compression power applied to the two-node link 48 due to up and down loads added to the front end side are absorbed by abutment against the guide grooves in the tangential direction provided to the guide members 52-1 and 52-2 for the connecting shafts 50-1 and 50-2, respectively, to reduce the tension and the compression power directly applied to the link plates 48-1 to 48-3. When one curved link plate is used in place of the two-node link 48, the tension or the compression power against the fixed side of the curved link plate caused by up and down power applied to the tip fitting 44 when the front end of the curved boom 20 is moved up and down may lead to occurrence of stress concentration in the approximate center portion of the curved link plate, followed by buckling and breakage. To prevent this, a link plate with significantly high rigidity should be used as the curved link plate. On the contrary, as in the present invention, the two-node link 48 is used in place of the one curved link plate, and the curved boom 20 side is restrained by the connecting shafts 50-1 and 50-2 with respect to the guide members 52-1 and 52-2; thereby a link with a low rigidity may suffice as a multiple node link member installed in the curved boom 20.

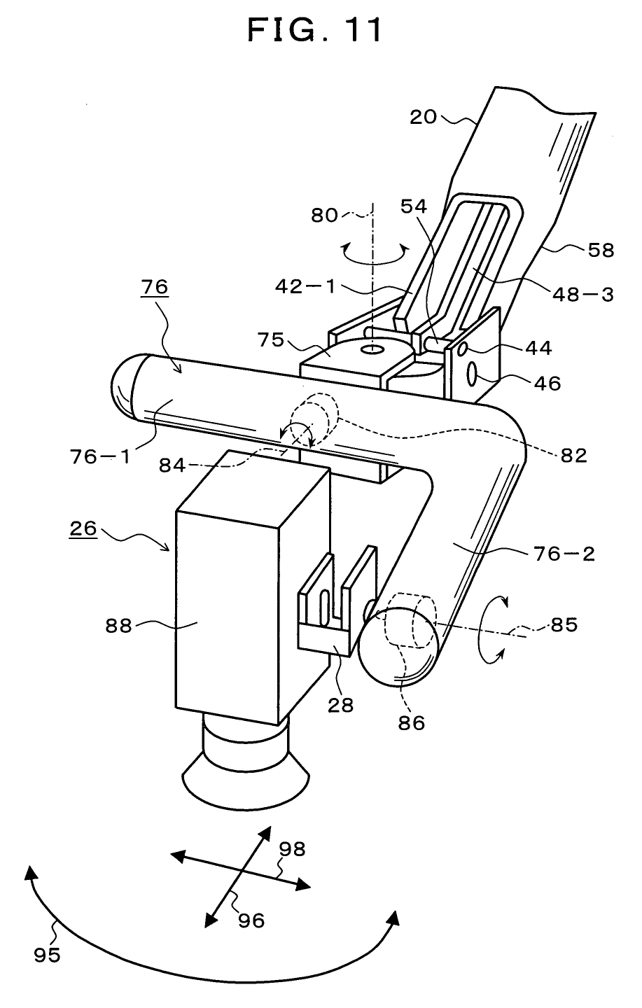

FIG. 11 is a detailed diagram to explain the pan head attached to the front end of the curved portion of the crane for shooting of the present invention. The pan head 26 has an oscillation mechanism by attaching an angle 75 roatatably around an axis 80 with respect to the tip fitting 44 of the curved boom 20. A pipe unit 76 curved into an L shape that is operable as a three-dimensional rotation mechanism is attached to an end of the angle 75 of this oscillation mechanism. In the pipe unit 76, a first rotation unit 76-1 serving as one side of the L shape is attached rotatably in vertical direction about an axis 84 with respect to the angle 75. With this axis 84 as a rotational center, a second motor 82 is installed inside the first rotation unit 76-1 of the pipe unit 76, and the pipe unit 76 is rotated about the axis 84 with respect to the angle 75 by the second motor 82. A third motor 86 is installed in side a second rotation unit 76-2 serving as the other side of the pipe unit 76, and the third motor 86 rotates the camera adaptor 28 about an axis 85. A small video camera 88 is attached downward to the camera adaptor 28.

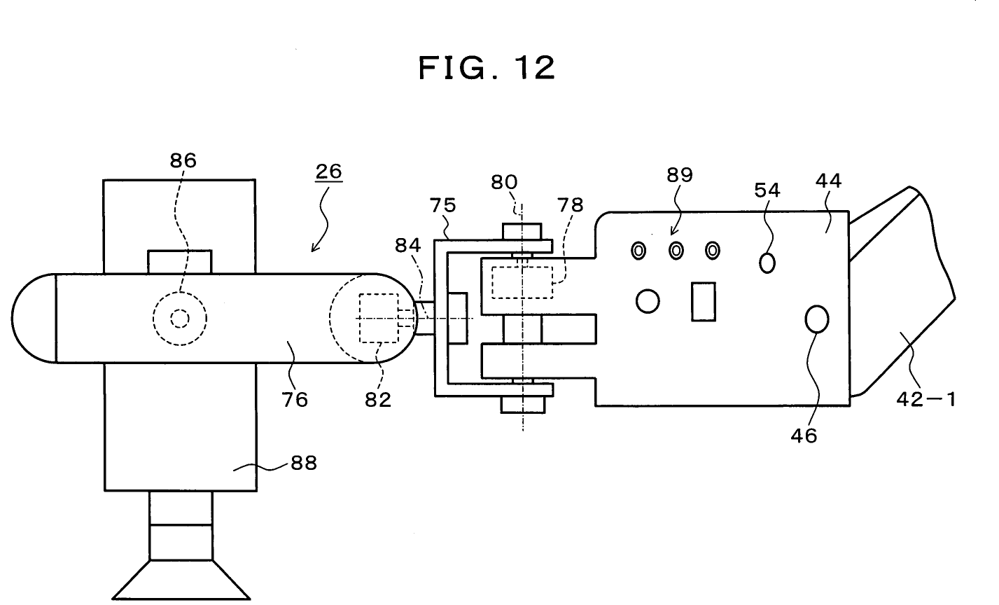

FIG. 12 is a side view of the pan head 26 in FIG. 11. In FIG. 12, the angle 75 having the oscillation mechanism provided rotatably in the horizontal direction with respect to the tip fitting 44 is attached, and the angle 75 is rotated about the axis 80, that is, in the horizontal direction, by a first motor 78 that is installed on the tip fitting 44 side, which allows the small video camera 88 attached on the pipe unit 76 side to be moved in an oscillating manner in the horizontal direction.

In this way with the pan head 26 of the crane for shooting of the present invention, it is possible to adjust not only right and left rotation in the horizontal direction shown by an arrow 95 with respect to shooting direction of the small video camera 88 in FIG. 12 but also movements in the right and left directions shown by an arrow 96 viewed from the small video camera 88 and in the up and down directions shown by an arrow 98 viewed from the small video camera 88 owing to provision of the oscillation mechanism that is rotated in the horizontal direction with respect to the front end of the curved boom 20 in addition to the three-dimensional rotation mechanism that is rotated in the vertical and horizontal directions.

Further, on the side face of the tip fitting 44, a video terminal unit 89 including a video signal terminal, an audio signal terminal, a digital video (DV) signal terminal, and a Lank signal terminal that connects a television camera is provided.

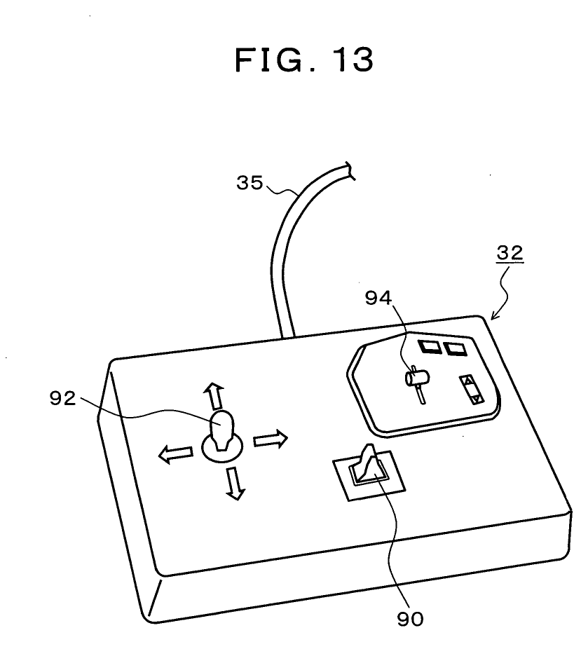

FIG. 13 is a detailed diagram to explain the operation box 32 that is used for the crane for shooting of the present invention. To the operation box 32, an oscillation operation switch 90, a four-direction operation switch 92, and a zoom operation switch 94 are provided. The angle 75 in FIG. 11 is rotated in the right and left directions by controlling the oscillation operation switch 90 to right or left. Further, when the four-direction operation switch 92 is controlled to the left or right direction, the third motor 86 inside the pipe unit 76 is rotated to move the small video camera 88 to the left or right direction shown by the arrow 96. Furthermore, when the four-direction operation switch 92 is controlled to the up or down direction, the small video camera 88 is rotated in the up or down direction shown by the arrow 98 by driving of the second motor 82 in the pipe unit 76. Still further, zoom-in and zoom-out of the small video camera 88 can be controlled by controlling the zoom switch 94 to the front or to the back. Such controls of shooting position and zooming of the small video camera 88 by the operation box 32 are controlled while watching images being shot on the monitor display 36 in FIG. 1. Note that, in this embodiment, a case where the operation box 32 is connected to the crane main body by cable is exemplified; however, remote control that does not require cable connection can be carried out by making use of radio or infrared rays for the operation box 32.

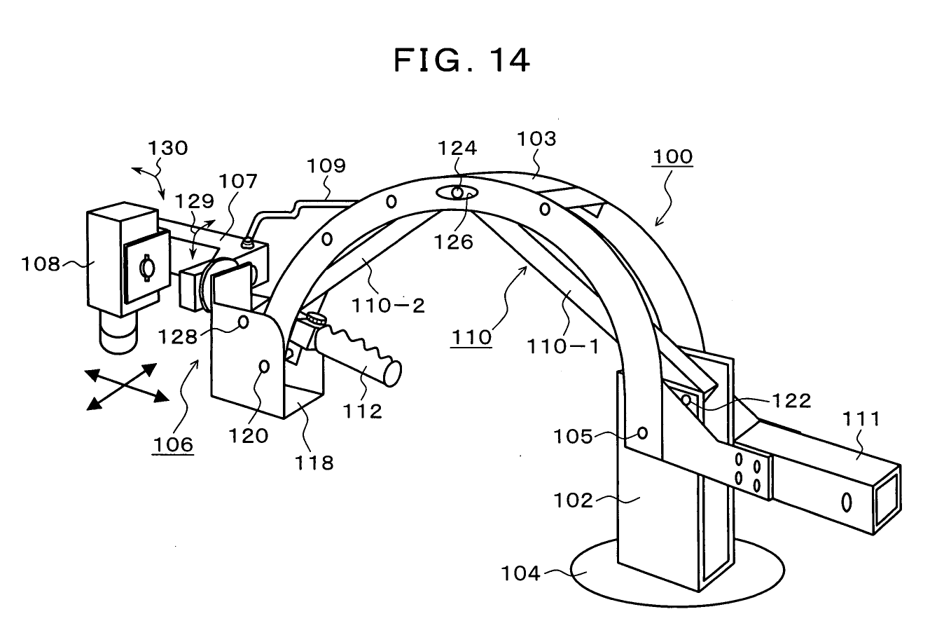

FIG. 14 is a detailed diagram to explain another embodiment of the crane for shooting according to the present invention. In this embodiment, in FIG. 14, a crane base unit 102 of a crane main body 100 is mounted on a pedestal 104, and a curved boom 103 is attached rotatably upward and downward with respect to the crane base unit 102 by a first supporting point shaft 105. In this embodiment, the curved boom 103 has an angle structure in which two curved plates are connected to each other at a plurality of points in the upper portion. The front end of the curved boom 103 is connected to a tip fitting 118 by a second supporting point shaft 120. Further, a weight attachment unit 111 is extended in the rear of the curved boom 103, and a weight is connected here. A one-node link member 110 is arranged inside the curved boom 103. In the one-node link member 110, link rods 110-1 and 110-2 are connected to each other by a connecting shaft 124. The rear end side of the one-node link member 110 is connected to the crane base unit 102 by a first supporting point shaft 105 and the front end side thereof is connected to the tip fitting 118 by a fourth supporting point shaft 128. The connecting shaft 124 that connects the link rods 110-1 and 110-2 is fit slidably and loosely in a guide groove 126 formed on the top side face of the curved boom 103. For this purpose, the curved boom 103 and the one-node link 110 are connected to each other by the first supporting point shaft 105 and a third supporting point shaft 122 with the crane base unit 102 as the fixed side, and the tip fitting 118 is connected as a movable side by the second supporting point shaft 120 and the fourth supporting point shaft 129; thereby a curved approximate parallel link mechanism is constructed.

A pan head 106 is attached to the tip fitting 118 at the front end of the curved boom 103. The pan head 106 is attached with an angle 107 in an L shape rotatably about an arrow 129 with respect to the tip fitting 118 and further with a small video camera 108 rotatably about an arrow 130 with respect to the angle 107. The rotations about the arrow 128 and about the arrow 130 are carried out by a motor installed in the angle 107. Further, an operation handle 112 is arranged in a downwardly projecting manner in the lower portion near the pan head 106 of the curved boom 103, which allow a staff member to adjust positions of the small video camera 108 while holding the operation handle 112 with one hand during surgery.

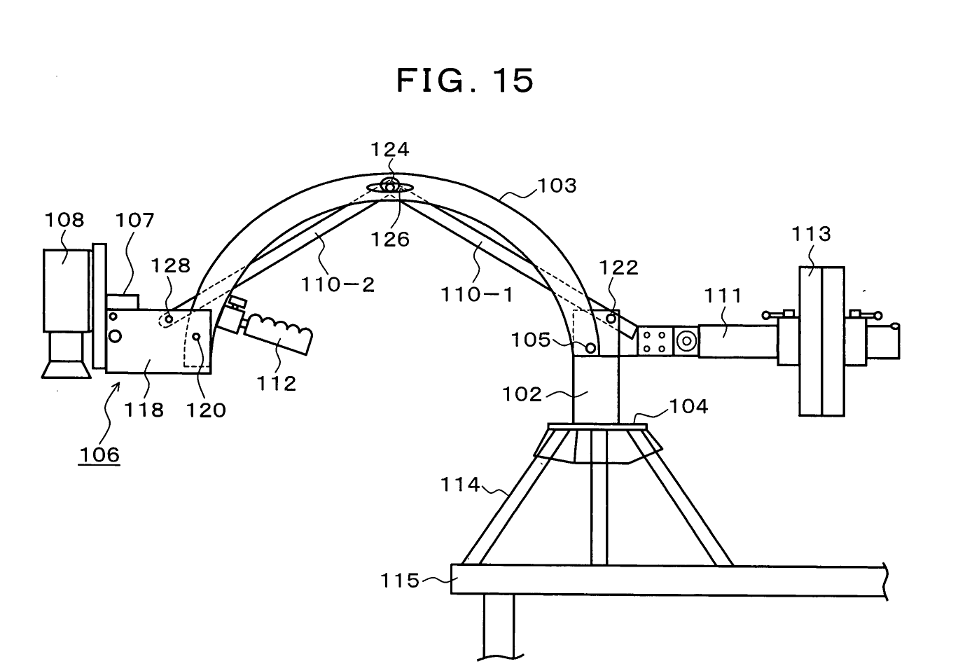

FIG. 15 is a side view of the boom of the embodiment in FIG. 14 in a horizontal position as well as a side view of a state in which a balance weight 113 is attached to the crane main body 100 via the weight attachment unit 111. Further, the crane main body 100 is fixed to the pedestal 104 and to a stand 115 via an attachment angle 114, and the stand 115 is formed on a cart with casters similarly to that of the embodiment in FIG. 1.

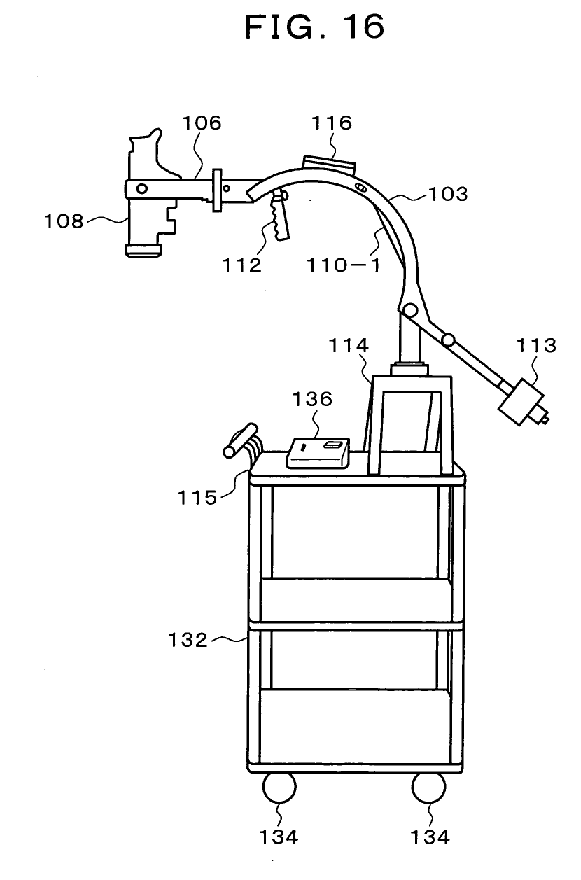

FIG. 16 is a detailed diagram to explain still another embodiment of the crane for shooting according to the present invention. Basically this embodiment is the same as those in FIG. 13 and FIG. 16. The stand 115 fixed with the crane main body 100 is fixed to a cart 132, and the cart 132 is provided with casters 134 and can be moved freely. Further, a control box 136 is placed on the stand 115 and can control the small video camera 108 attached to the pan head 106 in the horizontal and vertical directions in its downward state. Furthermore, in the embodiment in FIG. 16, a grip 116 used for carrying is provided in the upper portion of the curved boom 103.

Note that the above embodiments are exemplified for a case where shooting is carried out at a medical treatment site; however, the present invention is not limited to this, and when shooting is conducted at such a site that workers around a table work or give a treatment on the table, the embodiments can be employed for appropriate shooting applications as they are.

Further, in the above embodiments, the pan head provided with an oscillation mechanism and a three-dimensional rotation mechanism is as an example; however, a structure in which a small video camera is directly attached to the front end of the curved boom may be accepted. Furthermore, the present invention includes appropriate modifications without impairing its object and advantages and is not affected by the numerical value limitation shown in the above embodiments.

### INDUSTRIAL APPLICABILITY

As explained above, with the crane for shooting of the present invention, the crane stand is placed outside, for example, the necessary space surrounding, an operating table, and the pan head attached with a small video camera is positioned right above the operating table in a state where the curved boom crosses over the heads of staffs, and therefore, it is possible to accurately take pictures of surgery manners from right above without obstructing the surgery and disturbing the shooting views.

1. A crane for shooting comprising;
a crane base unit fixed on a movable stand;
a curved boom supported rotatably in the horizontal and up and down directions with respect to the crane base unit by means of a shaft and having an arch shape curved into an arc or U shape with downward opening;
a pan head that supports a shooting device provided to a front end of the curved boom;
a link mechanism that retains the pan head in a constant position with respect to rotation of the curved boom in the up and down directions; and
a weight for balance provided in the rear of the curved boom.

2. The crane for shooting according to claim 1, wherein the stand supports the curved boom such that the height of the inner side of the curve top thereof exceeds a man's height.

3. The crane for shooting according to claim 1, wherein the link mechanism is constructed of the curved boom and provided with a first link member one end of which is rotatably supported by means of a shaft at a first supporting point on the crane base unit and the other end of which is rotatably supported by means of a shaft at a second supporting point on the pan head side.
a second link member that is arranged along the first link member and makes use of a multiple node link one end of which is rotatably supported by a shaft at a third supporting point on the crane base unit and the other end of which is rotatably supported by means of a shaft at a fourth supporting point on the pan head side, and
a guide member that is fixed to the first link member and has guide grooves in the tangential direction in which the supporting points of the multiple node link of the second link member are fit slidably and loosely to restrain movement of the second link member with respect to the first link member.

4. The crane for shooting according to claim 3, wherein the first link member constructed of the curved boom is a curved pipe member, and the second link member is constructed by connecting a plurality of curved link plates to each other, and the connecting shafts of the multiple node link of the second link member are fit slidably and loosely in the guide grooves of the guide member fixed inside the pipe member.

5. The crane for shooting according to claim 4, wherein the second link member is a two-node link having three curved link plates connected to each other at two positions, and each link connecting shaft of the second link member is fit slidably and loosely in the guide grooves of the guide members fixed at two positions inside the curved pipe member constructing the first link member.

6. The crane for shooting according to claim 1, wherein the pan head includes
an oscillation mechanism unit that is provided to the front end of the curved boom and is rotatable in the horizontal direction,
a three-dimensional rotation mechanism that allows the attached shooting device to be rotated relatively in the horizontal and vertical directions with respect to the oscillation mechanism unit, and
a remote controlling unit that controls the oscillation mechanism and the three-dimensional rotation mechanism.

7. The crane for shooting according to claim 6, wherein the oscillation mechanism includes a first motor that rotates the pan head side in the horizontal direction with respect to the front end of the curved boom, and
the three-dimensional rotation mechanism that has a pipe member curved into an L shape and is not only provided rotatably with respect to the oscillation mechanism by a second motor installed inside on one side of the pipe member but also attached with an adaptor to hold the shooting device rotatably by a third motor installed inside on the other side of the pipe member.

8. The crane for shooting according to claim 6, wherein the remote controlling unit includes an operation switch for the oscillation mechanism, an operation switch for the three-dimensional rotation mechanism, and a zoom operation switch for the shooting device.

9. The crane for shooting according to claim 1, wherein a monitor display that displays images taken by the shooting device is provided on the stand on a cart.

10. The crane for shooting according to claim 1, wherein an operation handle is further provided in a downwardly projecting manner in the lower portion near the pan head of the curved boom.
